(19) United States
(12) Patent Application Publication
(10) Pub. No.: US 2003/0103229 A1
(43) Pub. Date: Jun. 5, 2003

(54) Printing for authorized users

(76) Inventor: Jeffrey Scott Weaver, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/998,797

(22) Filed: Dec. 3, 2001

(51) Int. Cl. B41F 1/00; G06F 15/00

(52) U.S. Cl. 358/1.14; 358/1.15

(57) ABSTRACT

Print systems are provided. A representative print system includes a printing device and a print authorization system. Preferably, the printing device includes a first print cartridge containing a print substance as well as a readable identification tag for providing first information. The printing device also includes an identification reader for receiving the first information. The identification reader enables the printing device to print if the first information corresponds to the printing device. The print authorization system is configured to receive, via a network, information to be printed and second information corresponding to a user. Third information can be received and, if the third information corresponds to the second information, the print authorization system enables the printing device to print the information to be printed. Methods, computer readable media and other systems also are provided.

### BACKGROUND OF THE INVENTION

1. Field of the Invention

The present invention generally relates to printing. In particular, the invention relates to systems and methods for providing authorized users with access to printed materials produced by printing devices.

2. Description of the Related Art

Computer networking enables multiple users to share hardware resources, such as printing devices. Although this can reduce costs, problems also can be created. For instance, when a user operating at a workstation that is remote from a shared printing device desires to print information, the user typically must initiate printing at the workstation and then walk to the printing device to retrieve the associated documents. As is known, queuing protocols can delay printing of the information. Thus, when the user arrives at the printing device, the documents may not yet be available.

Another problem relates to information security. More specifically, due the nature of the information that is to be printed, a user may desire that the documents be produced in a secure environment. In particular, the user may want to inhibit the ability of someone other than the user to retrieve the documents associated with the information. In the computer networking scenario described above, however, if the user is unable to be available at the printing device prior to the documents being printed, the printed documents may be retrieved by someone other than the user.

Based on the foregoing, it should be appreciated that there is a need for improved systems and methods which address these and/or other shortcomings of the prior art.

### SUMMARY OF THE INVENTION

The present invention relates to providing authorized users with access to documents produced by printing devices. In this regard, a representative embodiment of a print system of the invention includes a printing device and a print authorization system. The printing device includes a first print cartridge that contains a print substance for printing on a print medium. Preferably, the first print cartridge also includes a readable identification tag for providing first information. The printing device includes an identification reader that is configured to receive the first information. Preferably, the identification reader enables the printing device to print if the first information corresponds to the printing device.

The print authorization system of the print system communicates with the printing device. The print authorization system is configured to receive, via a communication network, information to be printed as well as second information corresponding to a user. Additionally, third information can be received by the print authorization system via the identification reader of the printing device. Thus, if the third information corresponds to the second information, the print authorization system enables the printing device to print the information to be printed.

Another embodiment of a print system includes a print authorization system. The print authorization system is configured to receive information to be printed and first information corresponding to a user via a computer network. Second information corresponding to a user also can be received. The print authorization system compares the first information to the second information and enables printing of the information to be printed if the second information corresponds to the first information.

A representative embodiment of a method for providing documents to an authorized user includes: receiving, via a computer network, information to be printed and first information corresponding to a user; receiving second information corresponding to a user; comparing the first information to the second information; and enabling printing of the information to be printed if the second information corresponds to the first information.

A representative embodiment of a computer readable medium that can be used with a printing device includes: logic configured to receive information to be printed and first information corresponding to a user; logic configured to receive second information corresponding to a user; logic configured to compare the first information to the second information; and logic configured to enable printing of the information to be printed if the second information corresponds to the first information.

### BRIEF DESCRIPTION OF THE DRAWINGS

The present invention, as defined in the claims, can be better understood with reference to the following drawings. The drawings are not necessarily to scale, emphasis instead being placed on clearly illustrating the principles of the present invention.

FIG. 1 is a schematic diagram of an embodiment of the print system of the present invention.

FIG. 2 is a flowchart depicting functionality of the embodiment of the print system of FIG. 1.

FIG. 3 is a schematic diagram of an embodiment of a printing device and associated identification information that can be used in the print system of FIG. 1.

FIG. 4 is a schematic diagram of another embodiment of a printing device as well as an associated identification tag that can be used in the print system of FIG. 1.

FIG. 5 is an embodiment of a computer or processor-based system that can be used to implement the print authorization system of FIG. 1.

FIG. 6 is a flowchart depicting functionality of an embodiment of the print authorization system of the present invention.

FIG. 7 is a schematic diagram of another embodiment of the print system of the present invention.

FIG. 8 is a flowchart depicting functionality of an embodiment of the print system of FIG. 7.

FIG. 9 is a flowchart depicting functionality of an embodiment of the user-end print authorization system of FIG. 7.

FIG. 10 is a schematic diagram depicting a representative graphical user interface of the user-end print authorization system of FIG. 9.

FIG. 11 is a flowchart depicting functionality of an embodiment of the print-end print authorization system of FIG. 7.

FIG. 12 is a flowchart depicting functionality of another embodiment of the print-end print authorization system of FIG. 7.

### DETAILED DESCRIPTION

As will be described in greater detail herein, systems and methods of the present invention potentially enable authorized users to retrieve printed documents from printing devices at their convenience. In particular, systems and methods of the invention can potentially alleviate the ability of another user, such as a user that does not possess a requisite level of authorization, to retrieve documents from the printing device. Preferably, such documents correspond to information to be printed that is directed to the printing device by the authorized user. In some embodiments, the authorized user can approach the printing device to which the information to be printed was directed and enable the printing device to print the information.

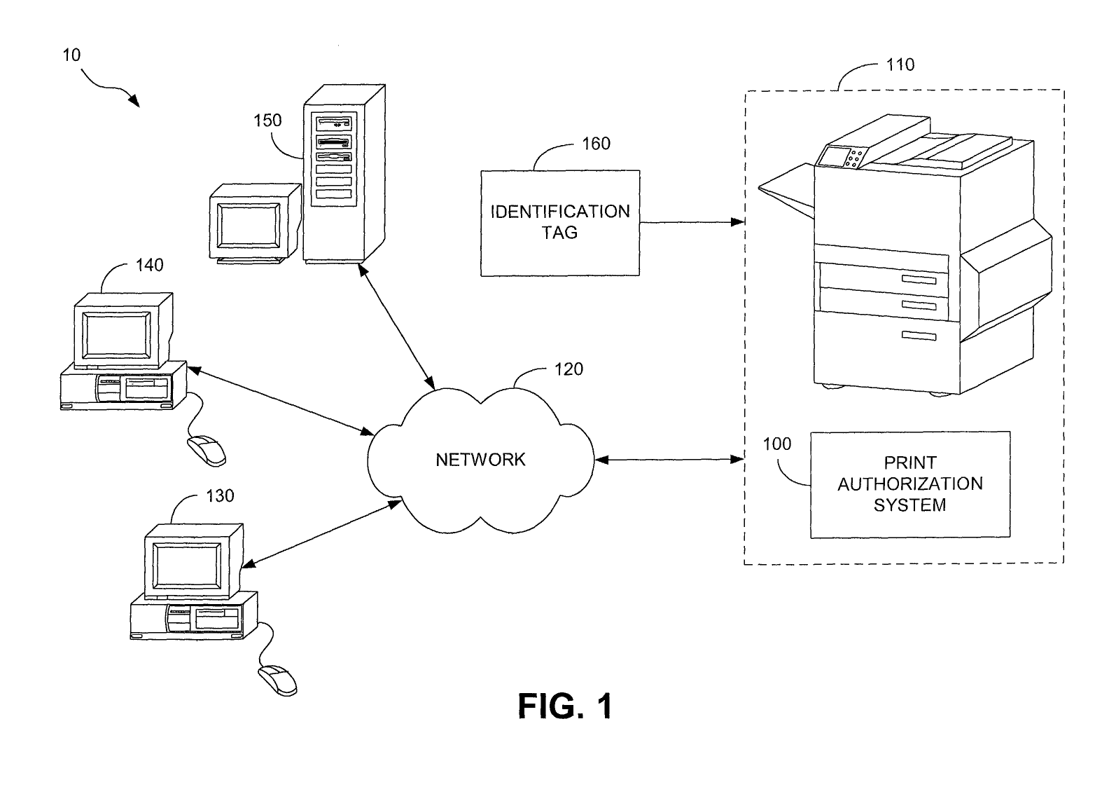

Reference will now be made to the drawings, wherein like reference numerals indicate corresponding components throughout the several views. As shown in FIG. 1, an embodiment of a print system 10 of the present invention can be implemented by a computer network. In FIG. 1, print system 10 includes a print authorization system 100 that is associated with a printing device 110. As used herein, “printing device” refers to any device(s) that is able to receive information and convert the information to hard copy. By way of example, printers, facsimile machines and multi-function devices are printing devices. The computer network of FIG. 1 also includes a communication network 120 that enables various devices to communicate with the printing device. In particular, workstations 130 and 140, and server 150 can communicate via the network.

Communication network 120 can employ any network topology, transmission medium, or network protocol. For example, the network(s) may be any public or private packet-switched or other data network, including circuit-switched networks, such as the public switched telephone network (PSTN), wireless network, or any other desired communications infrastructure and/or combination of infrastructures.

Also depicted in FIG. 1 is identification information 160. As will be described in greater detail herein, identification information 160 typically is associated with a user and is adapted to enable the user to retrieve documents from printing device 110. In particular, the identification information can interact with print authorization system 100 so that the print authorization system enables the printing device to print information that was directed to the printing device by the user.

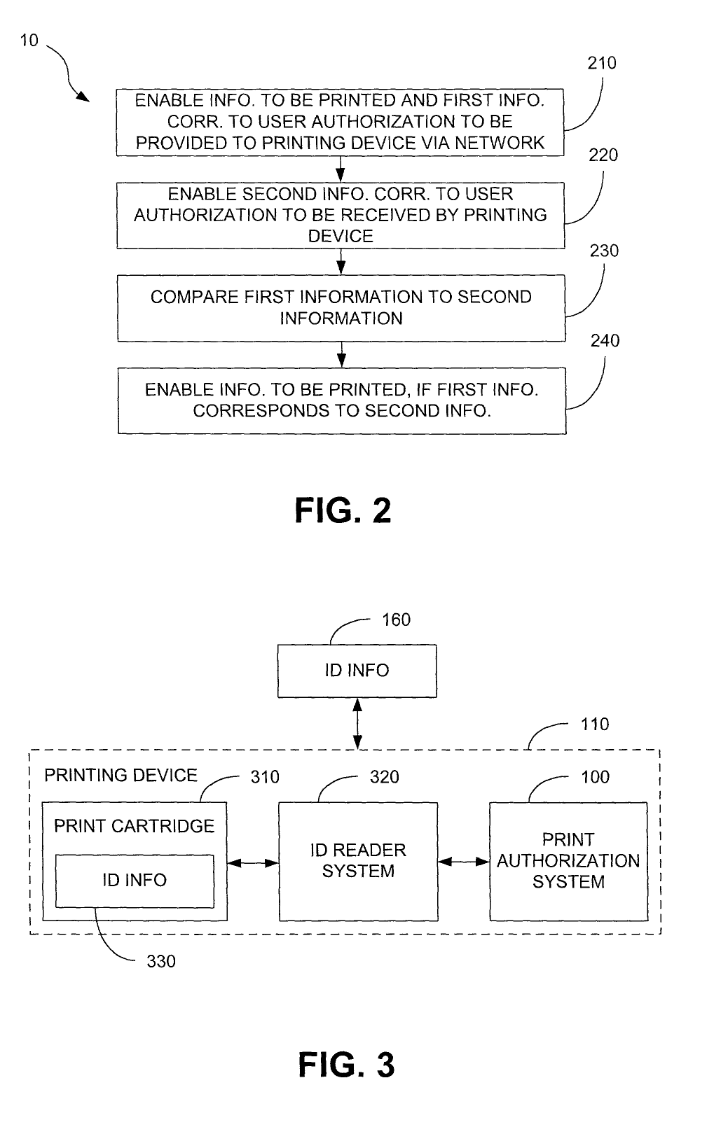

Functionality of the embodiment of print system 10 depicted in FIG. 1 is depicted in the flowchart of FIG. 2. As shown in FIG. 2, the print system or method 10 may be construed as beginning at block 210, where information to be printed and first information corresponding to the authorization of a user are enabled to be provided to a printing device. Preferably, the information to be printed and the first information are provided to the printing device via a communication network, such as network 120 of FIG. 1. In block 220, second information corresponding to the authorization of the user is enabled to be received by the printing device. As will be described later, the second information may be, or may be associated with, identification information 160 of FIG. 1. Typically, the second information is communicated directly to the printing device, e.g., the second information is not communicated to the printing device via communication network 120 of FIG. 1.

Proceeding to block 230, the first information and the second information are compared. Thereafter, such as depicted in block 240, if the first information corresponds to the second information, the information to be printed is enabled to be printed by the printing device. In some embodiments, second information can be substantially, continuously received and compared to the first information. In such an embodiment, if the second information is not being received and, thus, it cannot be determined whether the second information corresponds to the first information, printing of the information to be printed can be discontinued. In such an embodiment, printing can be resumed when the second information is received and the information correspond.

A representative printing device that can be used in print systems of the present invention will now be described with reference to the schematic diagram of FIG. 3. As shown in FIG. 3, printing device 110 includes a print cartridge 310 that contains a print substance, e.g., ink, toner, etc., for use by the printing device in performing a printing operation. Printing device 110 also includes an identification reader system 320 that is adapted to communicate with the print cartridge. In particular, although not required in all embodiments, the print cartridge can include identification information 330 that can be communicated to the identification reader system 320. In those embodiments where the print cartridge includes identification information, the printing device preferably is configured so that printing cannot be performed unless the print cartridge installed in the printing device is able to communicate identification information to the identification reader system. In such an embodiment, when the identification reader system detects the appropriate identification information from the print cartridge, e.g., the information corresponds to information stored by the printing device, print functionality of the printing device may be enabled.

As shown in FIG. 3, a print authorization system 100 also can be included in the printing device. As will be described in greater detail herein, print authorization system 100 preferably communicates with identification reader system 320. In particular, the identification reader system can be used to determine whether an authorized user has provided appropriate identification information, e.g., identification information 160, to the printing device so that printing can be enabled.

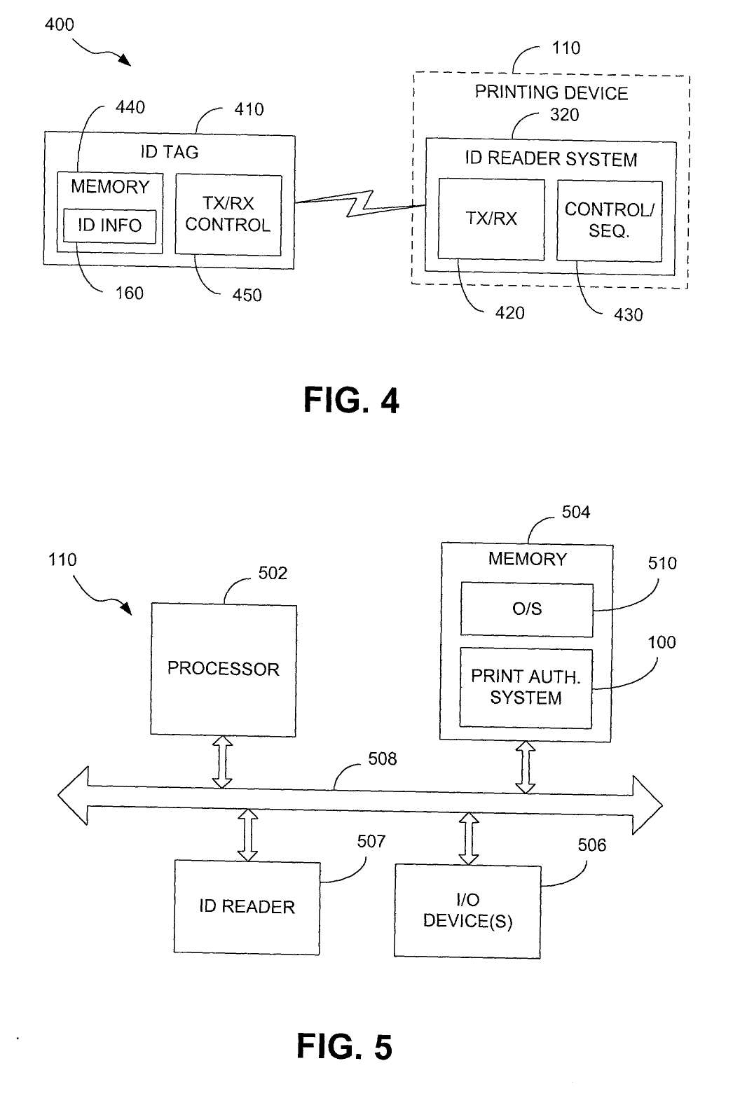

FIG. 4 is a schematic diagram depicting an embodiment of an identification tag/reader system 400 that can be used in print systems of the invention. As shown in FIG. 4, identification tag/reader system 400 includes an ID reader system 320 and an ID tag 410. Preferably, printing device 110 implements ID reader system 320, which includes a transmitter/receiver (Tx/Rx) 420 and a control/sequencer 430. Tx/Rx 420 modulates an RF carrier according to a selected protocol. The RF carrier is propagated by the Tx/Rx 420 and can be coupled to an antenna (not shown) of the ID tag 410. The ID tag rectifies the RF signal and uses the energy for powering various functions of the ID tag. For instance, the ID tag can store information in memory 440, e.g., non-volatile memory, and/or can retrieve data, such as identification information 160, for transmission back to the ID reader system.

In order to transmit data back to the ID reader system, the ID tag typically uses load modulation, where a resistive load is switched across a power bus (not shown) of the ID tag. This causes a change in the loading of the antenna (not shown) of the ID tag, with the change in the loading being detectable by the ID reader system. Switching of a resistive load can be accomplished by Tx/Rx control 450. Depending upon the frequency used, the transmission range of data from an ID tag to an ID reader system can vary. For example, transmission ranges can vary from fractions of inches to several feet. Clearly, one of ordinary skill in the art should be able to select a suitable frequency based on the particular application.

Other functionality also can be provided by embodiments of the identification tag/reader system 400. By way of example, the ID reader system can be configured to determine whether multiple ID tags are within the reception range of the reader and/or whether multiple ID tags are attempting to respond to the reader simultaneously. Additionally, data to be stored within an ID tag may be encrypted prior to transmission. Challenge/response techniques also may be used.

Reference will now be made to the schematic diagram of FIG. 5, which depicts a representative embodiment of a printing device 110 that can be used to implement a print authorization system 100. Note, print authorization system 100 can be implemented in software, firmware, hardware, or a combination thereof. When implemented in hardware, print authorization system 100 can be implemented with any or a combination of various technologies. By way of example, the following technologies, which are each well known in the art, can be used: a discrete logic circuit(s) having logic gates for implementing logic functions upon data signals, an application specific integrated circuit (ASIC) having appropriate combinational logic gates, a programmable gate array(s) (PGA), and a field programmable gate array (FPGA).

When implemented in software, print authorization system 100 can be a program that is executable by a computer or processor-based device. For the purpose of the following discussion, printing device 110 is considered an example of such a computer or processor-based device.

Generally, in terms of hardware architecture, printing device 110 of FIG. 5 includes a processor 502, memory 504, and one or more input and/or output (I/O) devices 506 (or peripherals) that are communicatively coupled via a local interface 508. Local interface 508 can be, for example, one or more buses or other wired or wireless connections, as is known in the art. Local interface 508 can include additional elements, which are omitted for ease of description. These additional elements can be controllers, buffers (caches), drivers, repeaters, and/or receivers, for example. Further, the local interface may include address, control, and/or data connections to enable appropriate communications among the components of printing device 110.

Processor 502 can be a hardware device configured to execute software that can be stored in memory 504. Processor 502 can be any custom made or commercially available processor, a central processing unit (CPU) or an auxiliary processor among several processors. Additionally, the processor can be a semiconductor-based microprocessor (in the form of a microchip), for example.

Memory 504 can include any combination of volatile memory elements (e.g., random access memory (RAM, such as DRAM, SRAM, etc.)) and/or nonvolatile memory elements (e.g., ROM, hard drive, tape, CDROM, etc.). Moreover, memory 504 can incorporate electronic, magnetic, optical, and/or other types of storage media. Note that memory 504 can have a distributed architecture, where various components are situated remote from one another, but can be accessed by processor 502.

The software in memory 504 can include one or more separate programs, each of which comprises an ordered listing of executable instructions for implementing logical functions. The software in the memory 504 includes print authorization system 100 and a suitable operating system (O/S) 510. The operating system 510 controls the execution of other computer programs, such as print authorization system 100. Operating system 510 also can provide scheduling, input-output control, file and data management, memory management, and communication control and related services.

The I/O device(s) 506 can include input devices, such as a keypad, for example. I/O device(s) 506 also can include output devices, such as a display device and printing mechanism(s), for example. I/O device(s) 506 may further include devices that are configured to communicate both inputs and outputs, such as a network communication port and ID reader system 507, for example.

When the printing device 110 is in operation, processor 502 is configured to execute software stored within the memory 504, communicate data to and from the memory 504, and generally control operations of the printing device 110. Print authorization system 100 and the O/S 510, in whole or in part, are read by the processor 502, perhaps buffered within processor 502, and then executed.

When print authorization system 100 is implemented in software, it should be noted that the print authorization system can be stored on any computer readable medium for use by or in connection with any computer-related system or method. In the context of this document, a computer-readable medium is an electronic, magnetic, optical, or other physical device or means that can contain or store a computer program for use by or in connection with a computer-related system or method. Print authorization system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer readable medium can be, for example but not limited to, an electronic, magnetic, optical, electromagnetic, infrared, or semiconductor system, apparatus, device, or propagation medium. More specific examples (a nonexhaustive list) of a computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

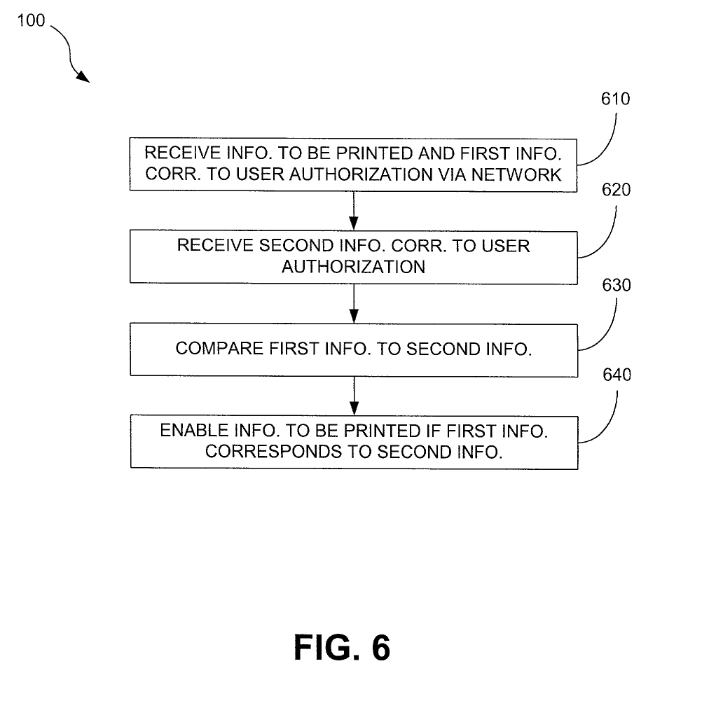

Reference will now be made to the flowchart of FIG. 6, which depicts the functionality of a representative embodiment of print authorization system 100. In this regard, each block of the flowchart represents a module segment or portion of code that comprises one or more executable instructions, or logic for implementing the specified logical function(s). It should also be noted that in some alternative implementations the functions noted in various blocks of FIG. 6, or any other of the accompanying flowcharts, may occur out of the order in which they are depicted. For example, two blocks shown in succession in FIG. 6 may, in fact, be executed substantially concurrently. In other embodiments, the blocks may sometimes be executed in the reverse order depending upon the functionality involved.

As shown in the flowchart of FIG. 6, print authorization system or method 100 may construed as beginning at block 610, where information to be printed as well as first information corresponding to the authorization of a user are received. Preferably, the information to be printed and the first information are received via a communication network. In block 620, second information corresponding to the authorization of the user is received. In block 630, the first information and second information are compared. Thereafter, such as depicted in block 640, if the first information corresponds to the second information, the information to be printed can be enabled to be printed.

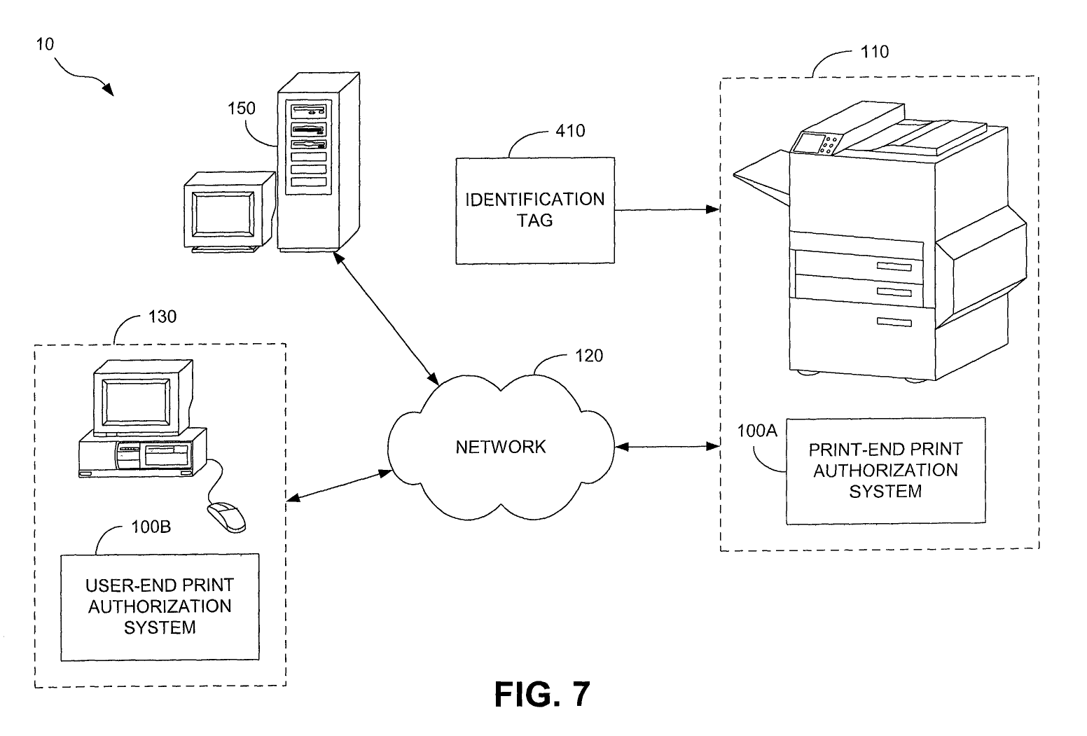

Reference will now be made to the schematic diagram of FIG. 7, which depicts another embodiment of a print system 10 of the present invention. As shown in FIG. 7, print system 10 includes a print-end print authorization system 100A, which is associated with a printing device 110, as well as a user-end print authorization system 100B. Typically, the user-end print authorization system 100B is associated with a device that is capable of providing information to be printed to the printing device. By way of example, the user-end print authorization system can be associated with a workstation, e.g., workstation 130, a laptop, etc.

In FIG. 7, the user-end print authorization system 100B communicates with the print-end print authorization system 100A via a communication network 120. Various other devices also can communicate via the network, such as a server 150. Also depicted in FIG. 7 is an identification tag 410 that can enable a user to retrieve documents from the printing device.

Each of the user-end and print-end print authorization systems can be implemented in software, firmware, hardware, or a combination thereof. Additionally, the devices with which the user-end and print-end print authorization systems are implemented can be computer or processor-based devices. Since such a device was described herein in relation to the schematic diagram of FIG. 5, no further description of such a device will be provided here.

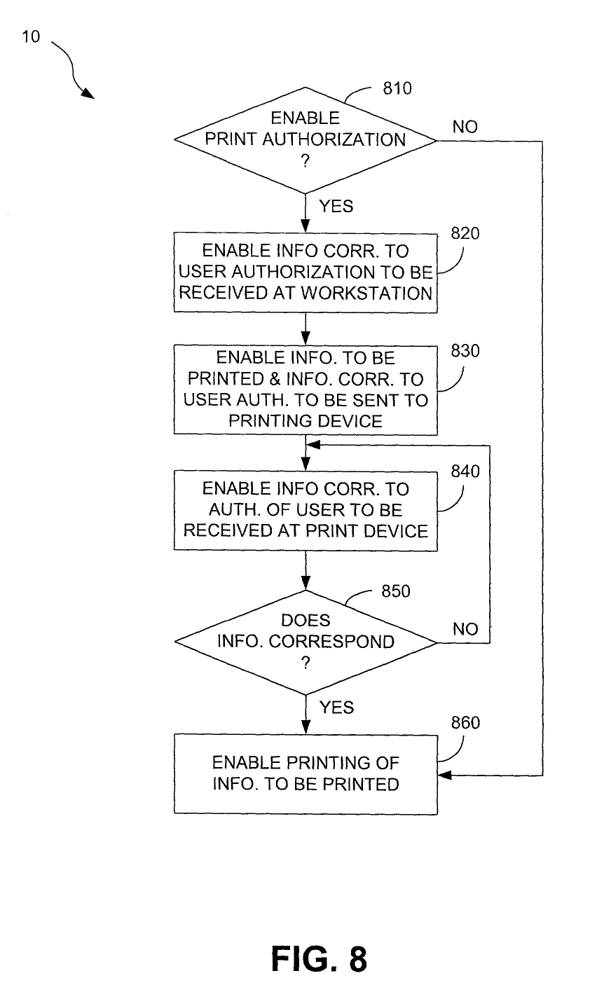

Referring now to the flowchart of FIG. 8, functionality of the embodiment of the print system 10 of FIG. 7 will be described. As shown in FIG. 8, the print system or method 10 may be construed as beginning at block 810, where a determination is made as to whether print authorization functionality is to be enabled. If it is determined in block 810 that print authorization functionality is to be enabled, the process may proceed to block 820, where information corresponding to the authorization of a user is enabled to be received. Preferably, the user authorization is received at the device(s), e.g., workstation 130 of FIG. 7, that is used to provide information to be printed to the printing device. In block 830, the information to be printed, as well as the information corresponding to the authorization of the user, is enabled to be sent to the printing device.

Proceeding to block 840, information corresponding to the authorization of the user is enabled to be received at the printing device. Thereafter, such as depicted in block 850, a determination is enabled to be made as to whether the information received at the printing device corresponds to the information provided with the information to be printed. If it is determined that the information correspond, the process may proceed to block 860, where printing of the information to be printed is enabled. Note, the process also can proceed to block 860 when it is determined that print authorization functionality is not to be enabled (block 810). If, however, it is determined that the information do not correspond, the process may return to block 840 and proceed as described hereinbefore.

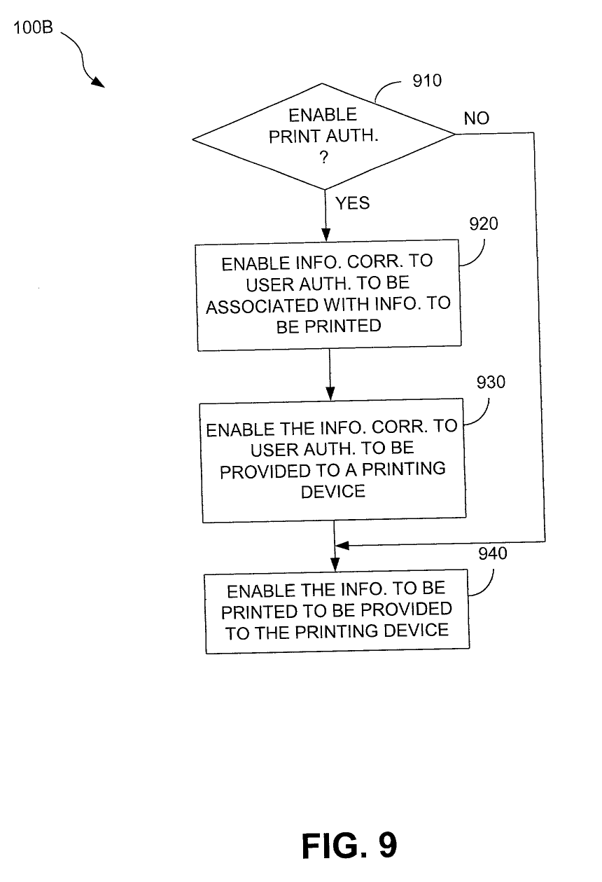

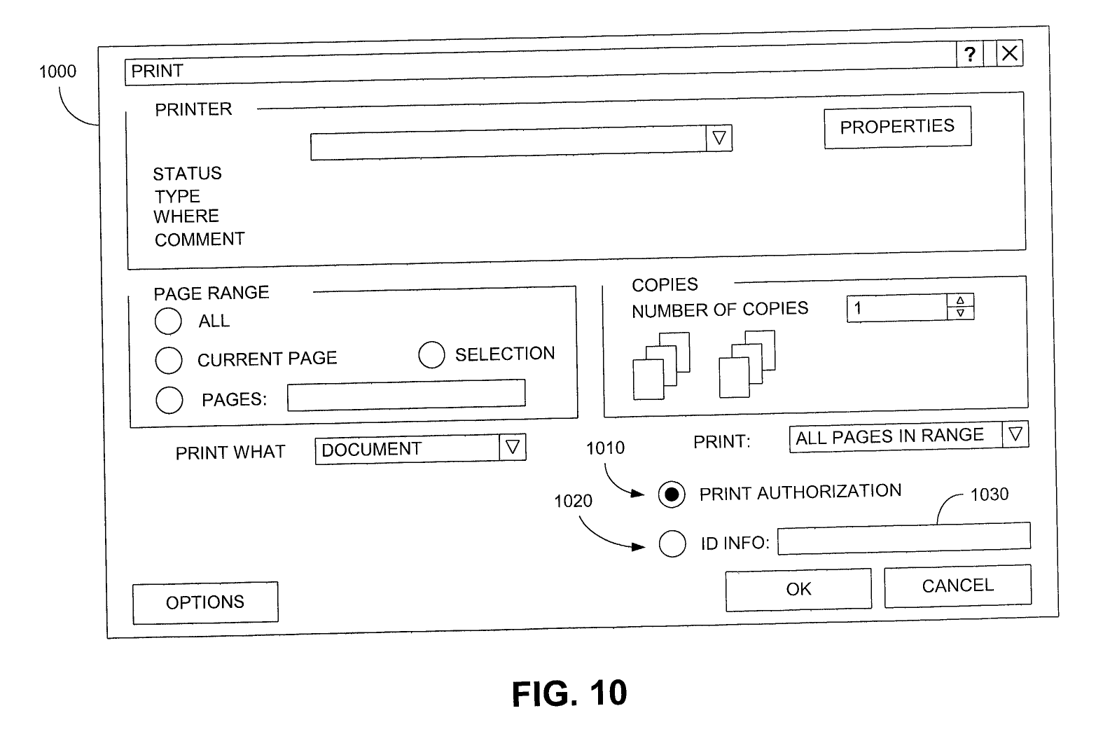

The functionality of an embodiment of the user-end print authorization system 100B will now be described with reference to the flowchart of FIG. 9. As shown in FIG. 9, the user-end print authorization system or method 100B may be construed as beginning at block 910, where a determination is made as to whether print authorization functionality is to be enabled. If it is determined that print authorization functionality is to be enabled, i.e., printing is to be accomplished in a secure-enable mode, the process may proceed to block 920. In block 920, information corresponding to the authorization of a user is enabled to be associated with information that the user intends to have printed. In some embodiments, this can be accomplished by a graphical user interface (GUI) that is displayed to the user via a display device. A representative GUI for performing this functionality is depicted in the schematic diagram of FIG. 10.

As shown in FIG. 10, GUI 1000 can enable functions typically provided by print driver interfaces. In addition thereto, and/or in lieu thereof, GUI 1000 can provide a print authorization actuator 1010, an identification information actuator 1020 and an associated information field 1030. In operation, a user can associate previously stored identification information associated with the user with information that the user intends to print by actuating the print authorization actuator 1010. If, however, previously stored identification information is not available or if the user desires not to use previously stored identification information, the user could actuate the identification information actuator 1020. Once actuated, the user could provide the desired identification information within field 1030. Upon actuating the “okay” actuator 1050, the information to be printed as well as the information corresponding to the authorization of the user, i.e., the identification information, is enabled to be sent to the printing device.

Referring once again to the flowchart of FIG. 9, the aforementioned functionality of enabling the information corresponding to the authorization of the user to be provided to a printing device is depicted in block 930. In block 940, the information to be printed is enabled to be provided to the printing device. Note, by using a graphical user interface, for example, the functionality depicted in blocks 930 and 940 can be executed substantially simultaneously.

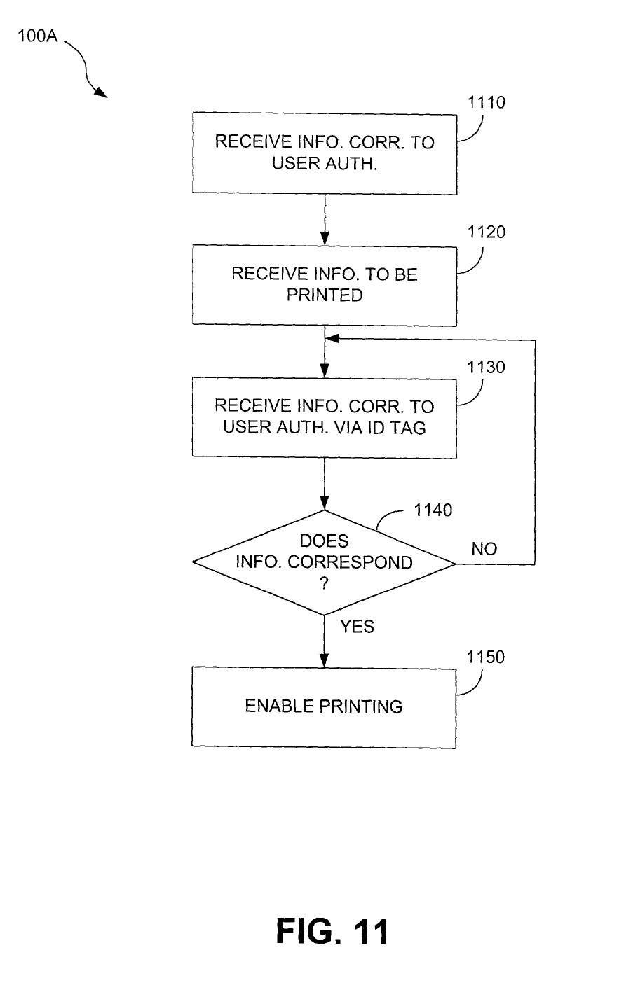

Functionality of a representative embodiment of the print-end print authorization system 100A will now be described with reference to the flowchart of FIG. 11. As shown in FIG. 11, the print-end print authorization system or method 100A may be construed as beginning at block 1110, where information corresponding to the authorization of a user is received. In block 1120, information to be printed also is received. By way of example, both the information to be printed and the information corresponding to the authorization of the user may be received via a communication network, e.g., network 120 of FIG. 7.

Proceeding to block 1130, information corresponding to the authorization of the user is received from an identification tag. For instance, the identification tag can be carried by the user and can be provided in a proximity of the printing device so that the identification reader system of the printing device can acquire identification information from the ID tag. In some embodiments, the reader system can include a receiver that is arranged close enough to an exterior surface of the printing device so that the identification tag can be placed near an outer surface of the printing device for reading. In other embodiments, the printing device can incorporate a slot, for example, into which the identification tag can be placed so as to provide the identification tag in close enough proximity to the reader system so that information can be received from the ID tag.

Regardless of the particular configuration utilized, in block 1140, a determination is made as to whether the information corresponding to the authorization of the user provided in block 1110 corresponds with the information provided by the identification tag. If it is determined that the information correspond, the process may proceed to block 1150, where printing of the information to be printed is enabled. If, however, the information do not correspond, the process may return to block 1130.

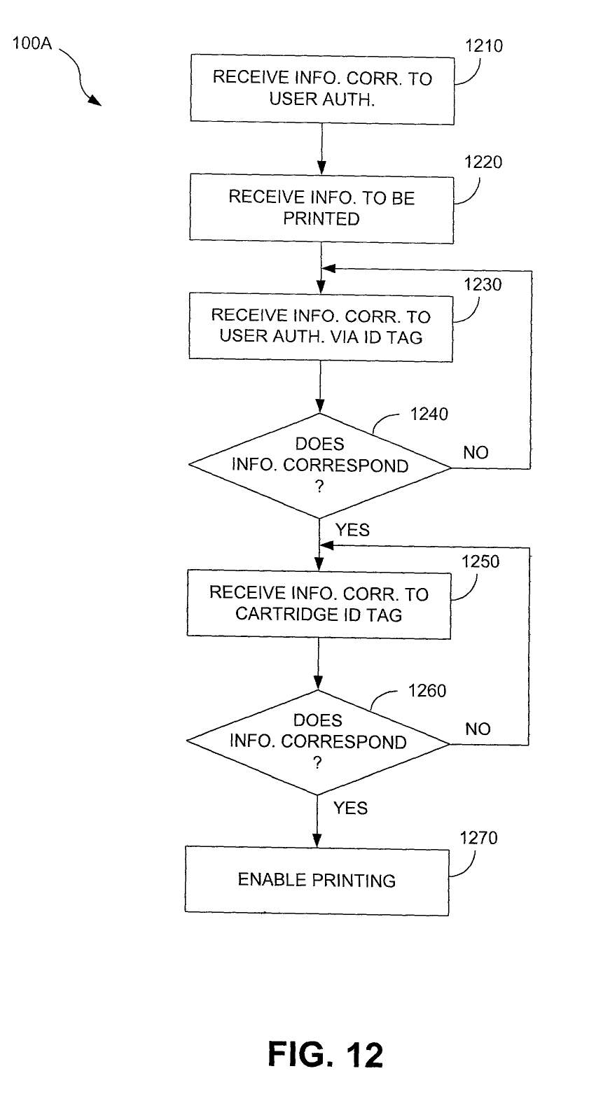

Functionality of another representative embodiment of the print-end print authorization system 100A will now be described with reference to the flowchart of FIG. 12. As shown in FIG. 12, the print-end print authorization system or method 100A may be construed as beginning at block 1210, where information corresponding to the authorization of a user is received. In block 1220, information to be printed also is received. Thereafter, such as depicted in block 1230, information corresponding to the authorization of the user is received from an identification tag. Then, in block 1240, a determination is made as to whether the information corresponding to the authorization of the user provided in block 1210 corresponds with the information provided via the identification tag. If the information do not correspond, the process may return to block 1230. If it is determined that the information correspond, the process may proceed to block 1250.

In block 1250, information corresponding to identification information of the print cartridge of the printing device is received (see identification information 330 of FIG. 3). Thereafter, such as depicted in block 1260, a determination is made as to whether the identification information provided by the print cartridge corresponds to information stored by the printing device. In particular, the printing device can be configured to store identification information known to be associated and/or otherwise authorized for use with the printing device. If it is determined that the identification information of the print cartridge is associated with the printing device, the process may proceed to block 1270, where printing is enabled. If, however, it is determined that the identification information of the print cartridge is not properly associated with the printing device, the process may return to block 1250, thereby effectively disabling printing until the appropriate identification information is received from the print cartridge.

The foregoing description has been presented for purposes of illustration and description. It is not intended to be exhaustive or to limit the invention to the precise forms disclosed. Modifications and/or variations are possible in light of the above teachings. The embodiments discussed, however, were chosen and described to illustrate the principles of the invention and its practical application to thereby enable one of ordinary skill in the art to utilize the invention in various embodiments and with various modifications as are suited to the particular use contemplated. All such modifications and variations are within the scope of the invention as determined by the appended claims.

1. A method for providing documents to an authorized user, said method comprising:
receiving, via a computer network, information to be printed and first information corresponding to a user;
receiving second information corresponding to a user;
comparing the first information to the second information; and
enabling printing of the information to be printed if the second information corresponds to the first information.

2. The method of claim 1, further comprising:
providing a printing device; and
wherein receiving second information corresponding to a user comprises:
receiving the second information from the user at the printing device.

3. The method of claim 2, further comprising:
providing an identification device configured to transmit the second information; and
wherein receiving the second information is enabled when the identification device is in a proximity of the printing device.

4. The method of claim 2, further comprising:
storing third information;
providing a print cartridge configured to transmit fourth information, said print cartridge being installed in the printing device and containing ink for printing;
comparing the third information to the fourth information; and
enabling printing of the information to be printed if the fourth information corresponds to the third information.

5. The method of claim 4, wherein storing the third information and comparing the third information to the fourth information is performed at the printing device.

6. The method of claim 1, further comprising:
determining whether the second information is being received; and
discontinuing printing of the information to be printed if the second information is not being received.

7. The method of claim 1, further comprising:
preventing the information to be printed from being printed if the second information does not correspond to the first information.

8. The method of claim 1, further comprising:
storing the information to be printed and the first information at a time after receipt; and
erasing the information to be printed at a time after printing.

9. A print system comprising:
a printing device having a first print cartridge and an identification reader, the first print cartridge containing a print substance for printing on a print medium, the first cartridge having a transmitter readable identification tag for providing first information, the identification reader being configured to receive the first information from the identification tag, such that, if the first information corresponds to the printing device, the identification reader enables the printing device to print; and
a print authorization system communicating with the printing device, the print authorization system being configured to receive, via a communication network, information to be printed and second information corresponding to a user, said print authorization system being further configured to receive third information corresponding to a user via the identification reader such that, if the third information corresponds to the second information, the print authorization system enables the printing device to print the information to be printed.

10. The print system of claim 9, wherein the identification reader includes a receiver, the receiver being adapted to receive the first and third information via wireless communication.

11. The print system of claim 9, wherein the identification reader includes means for receiving information via wireless communication.

12. The print system of claim 9, further comprising:
user identification tag adapted to communicate with the identification reader via wireless communication, the identification tag including a memory, the memory storing data corresponding to the third information, the user identification tag being adapted to provide the third information to the identification reader.

13. The print system of claim 9, further comprising:
a second print cartridge having an identification reader, the second print cartridge containing a print substance for printing on a print medium and a readable identification tag for providing the first information, the second print cartridge being adapted to be installed in the printing device after the first print cartridge is removed from the printing device.

14. The print system of claim 9, wherein the print authorization system is a print-end print authorization system implemented by the printing device; and further comprising:
a user-end print authorization system adapted to communicate with the printing device, the user-end print authorization system being configured to enable a user to provide the second information to the print-end print authorization system via a communication network.

15. The print system of claim 14, wherein the user-end print authorization system is adapted to provide a user interface, the user interface enabling a user to designate information to be printed and select a secure-enable mode such that, when the user selects the secure-enable mode, the information to be printed can only be printed by the printing device while the identification reader receives the third information.

16. The print system of claim 9, wherein the printing device includes memory, the printing device being configured to store the information to be printed and the first information in the memory at a time after receipt, the printing device being further configured to render the information to be printed inaccessible from the memory at a time after printing.

17. A print system comprising:
a print authorization system configured to:
receive, via a computer network, information to be printed and first information corresponding to a user;
receive second information corresponding to a user;
compare the first information to the second information; and
enable printing of the information to be printed if the second information corresponds to the first information.

18. The print system of claim 17, wherein the print authorization system is further configured to determine whether the second information is being received and discontinue printing of the information to be printed if the second information is not being received.

19. The print system of claim 17, further comprising:
a printing device communicating with the print authorization system, the printing device having a first print cartridge and an identification reader, the first print cartridge containing a print substance for printing on a print medium, the first cartridge having a readable identification tag for providing first information, the identification reader being configured to receive the first information from the identification tag, such that, if the first information corresponds to the printing device, the identification reader enables the printing device to print; and
wherein the print authorization system is implemented in logic associated with the printing device.

20. A computer readable medium comprising:
logic configured to receive information to be printed and first information corresponding to a user;
logic configured to receive second information corresponding to a user;
logic configured to compare the first information to the second information; and
logic configured to enable printing of the information to be printed if the second information corresponds to the first information.

21. The computer readable medium of claim 20, further comprising:
logic configured to determine whether the second information is being received; and
logic configured to discontinue printing of the information to be printed if the second information is not being received.
